(19) United States
(12) Patent Application Publication
(10) Pub. No.: US 2021/0343162 A1
(43) Pub. Date: Nov. 4, 2021

(54) INFORMATION PROCESSING APPARATUS

(71) Applicant: NTT DOCOMO, INC., Tokyo (JP)

(72) Inventors: Tadao TAKAMI, Tokyo (JP); Koji ISHII, Tokyo (JP); Jooin WOO, Tokyo (JP); Hiroshi KAWAKAMI, Tokyo (JP); Kaori NIIHATA, Tokyo (JP); Yuichiro SEGAWA, Tokyo (JP); Yasuhiro KITAMURA, Tokyo (JP)

(73) Assignee: NTT DOCOMO, INC., Tokyo (JP)

(21) Appl. No.: 17/283,165

(22) PCT Filed: Oct. 28, 2019
(86) PCT No.: PCT/JP2019/042193

§ 371 Date: Apr. 6, 2021

(30) Foreign Application Priority Data
Dec. 14, 2018 (JP) 2018-234331

(51) Int. Cl. G08G 5/00

(52) U.S. Cl. CPC G08G 5/0034; G08G 5/0047

(57) ABSTRACT

In a server device, an acquisition unit acquires information generated by a first detection unit and a second detection unit through a network. An identification unit identifies a wind condition and the state of flight of an aerial vehicle on the basis of the information acquired by the acquisition unit. More specifically, the identification unit identifies the wind direction and the wind speed, which indicate the wind condition, and the position, the flight direction, and the flight speed of the aerial vehicle, which indicate the state of flight of the aerial vehicle. The estimation unit estimates a landing area where the aerial vehicle is likely to land according to the wind condition and the state of flight of the aerial vehicle which have been identified.

### TECHNICAL FIELD

The present invention relates to a technique for estimating an area where an aerial vehicle may land.

### BACKGROUND ART

Unmanned aerial vehicles called drones are becoming increasingly popular. For example, Patent Document 1 discloses a technique for achieving accurate landing of an unmanned aerial vehicle thereby to reduce the area required for the landing.

### CITATION LIST

### Patent Documents

Patent Document 1: Japanese Patent Application Laid-Open No. 2010-269724

### SUMMARY OF THE INVENTION

### Problems to be Solved by the Invention

This type of aerial vehicles is easily affected by wind and the like, so that a situation in which the landing position is different from an expected position tends to occur. For this reason, measures are required whereby, for example, to estimate an area of a certain size beforehand as an area where an aerial vehicle may land and to prohibit another aerial vehicle or a human from entering the area.

An object of the present invention, therefore, is to further accurately estimate an area where an aerial vehicle may land.

### Means for Solving the Problems

To this end, the present invention provides an information processing apparatus including: an identification unit that identifies a wind condition in a flight airspace of an aerial vehicle; and an estimation unit that estimates a landing area where the aerial vehicle is likely to land according to the identified wind condition.

The estimation unit may estimate the landing area according to a flying state of the aerial vehicle at the time of landing.

The estimation unit may estimate the landing area according to a relationship between a wind direction and a wind speed of the wind identified as the wind condition and a flight direction and a flight speed of the aerial vehicle at the time of landing.

The estimation unit may estimate the landing area according to a structure of the aerial vehicle related to flight.

The estimation unit may estimate the landing area according to wind countering performance of the aerial vehicle.

The estimation unit may estimate the landing area according to the weight of the aerial vehicle or the weight of a load of the aerial vehicle.

The estimation unit may estimate the landing area according to the technique of piloting the aerial vehicle.

The estimation unit may estimate the landing area according to a condition of a road surface onto which the aerial vehicle lands.

The estimation unit may estimate the landing area according to the state of a missing radio signal for controlling the aerial vehicle.

### Effects of the Invention

According to the present invention, an area where an aerial vehicle may land can be further accurately estimated.

### BRIEF DESCRIPTION OF THE DRAWINGS

FIG. 1 is a diagram illustrating an example of the configuration of a flight control system 1;

FIG. 2 is a diagram illustrating the hardware configuration of an aerial vehicle 10;

FIG. 3 is a diagram illustrating the hardware configuration of a server device 20;

FIG. 4 is a diagram illustrating an example of the functional configuration of the flight control system 1;

FIG. 5 is a flowchart illustrating an example of the operation of the server device 20;

FIG. 6 is a plan view illustrating an example of the landing area of the aerial vehicle 10; and

FIG. 7 is a plan view illustrating an example of the landing area of the aerial vehicle 10.

### MODE FOR CARRYING OUT THE INVENTION

[Configuration]

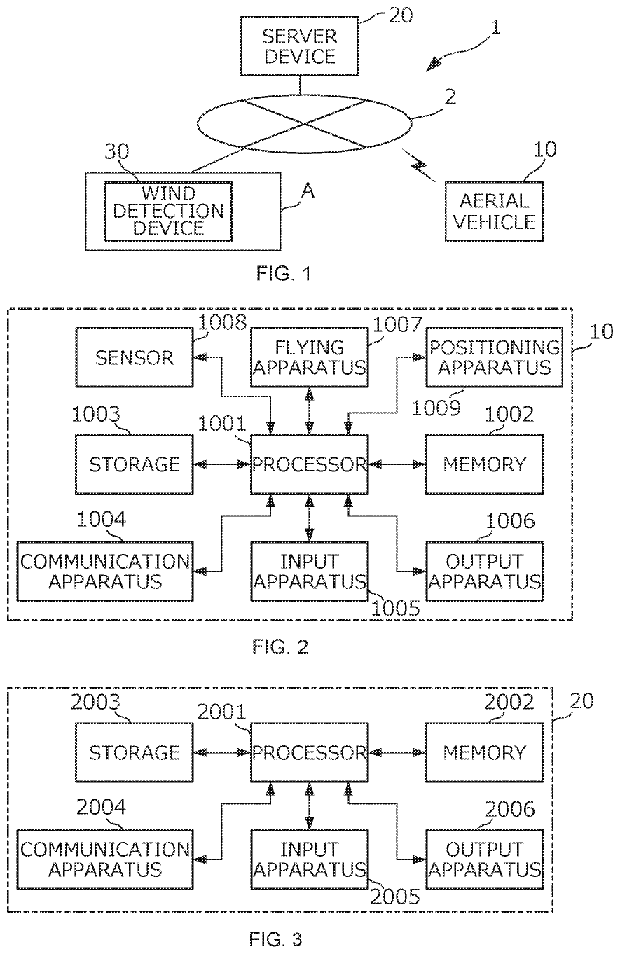

FIG. 1 is a diagram illustrating an example of the configuration of a flight control system 1. The flight control system 1 includes an unmanned aerial vehicle 10 called as, for example, a drone, a server device 20 as an information processing unit, a wind detection device 30, and a network 2 connecting these to make them communicable. The network 2 is a radio communication network, such as LTE (Long Term Evolution). The aerial vehicle 10 may alternatively be an aerial vehicle that flies in response to an operation of a piloting terminal by an operator, not illustrated, (so-called manual flight), or an aerial vehicle that flies autonomously under control conducted by a flight control device, not illustrated, (so-called automatic flight), or may be an aerial vehicle that uses both manual flight and automatic flight. In the present embodiment, a description will be given of an example of the aerial vehicle 10 of the automatic flight type that autonomously flies under control using radio signals through the network 2.

Zone A is a zone where a plurality of aerial vehicles 10 land. In order to avoid contact between the aerial vehicles 10 in this zone A, it is desirable that another aerial vehicle 10 does not enter an area required for a certain aerial vehicle 10 to land during the time zone of landing thereof.

However, the unmanned aerial vehicle 10 is smaller and lighter than a manned airplane, helicopter, or the like, so that the flight course is easily affected by wind. Therefore, even if the aerial vehicle 10 attempts to land at a certain landing target point, the actual landing point may change according to a wind condition. Hence, the server device 20 estimates a landing area that is an area where the aerial vehicle 10 is likely to land (more specifically, the landing possibility is equal to or more than a certain threshold value) according to the wind condition in the flight airspace of the aerial vehicle 10. Then, the server device 20 generates a landing schedule of a plurality of aerial vehicles 10 in zone A by spatially and temporally combining the landing areas estimated for the plurality of the aerial vehicles 10 in zone A.

The wind detection device 30 is a means for detecting a wind condition, and is connected to the network 2 in a wireless or wired manner. More specifically, the wind detection device 30 is a wind direction anemometer provided in or around zone A to detect the wind direction and the wind speed of the wind in an airspace which is the flight airspace of the aerial vehicle 10 and which significantly influences the identification of the landing area (in this case, the space from the ground in zone A to a predetermined altitude Xm).

FIG. 2 is a diagram illustrating the hardware configuration of the aerial vehicle 10. The aerial vehicle 10 is physically configured as a computer system that includes a processor 1001, a memory 1002, a storage 1003, a communication apparatus 1004, an input apparatus 1005, an output apparatus 1006, a flying apparatus 1007, a sensor 1008, a positioning apparatus 1009, and a bus that connects these constituent elements. Each of these apparatuses operates with electric power supplied from a battery (not shown). In the following description, the term “apparatus” can be read as a circuit, a device, a unit, or the like. The hardware configuration of the aerial vehicle 10 may be formed to include one device or a plurality of devices illustrated in the drawing, or may be configured without including some devices.

The functions of the aerial vehicle 10 are performed by reading predetermined software (program) on hardware such as the processor 1001 and the memory 1002, so that the processor 1001 performs an operation, the communication is controlled by the communication apparatus 1004, and at least one of reading and writing of data in the memory 1002 and the storage 1003 is controlled.

The processor 1001 controls, for example, the entire computer by operating an operating system. The processor 1001 may be composed of a central processing unit (CPU) that includes an interface with peripheral devices, a control unit, an arithmetic unit, a register, and the like. Further, for example, a baseband signal processing unit, a call processing unit, and the like may be implemented by the processor 1001.

The processor 1001 reads out a program (program code), a software module, data, and the like from at least one of the storage 1003 and the communication apparatus 1004 to the memory 1002, and executes various types of processing according to these. As the program, a program that causes a computer to execute at least a part of the operations described below is used. The functional blocks of the aerial vehicle 10 may be implemented by a control program stored in the memory 1002 and run by the processor 1001. Various types of processing may be executed by one processor 1001, or may be executed simultaneously or sequentially by two or more processors 1001. The processor 1001 may be implemented by one or more chips. The program may be transmitted from the network 2 to the aerial vehicle 10 through a telecommunication line.

The memory 1002 is a computer-readable recording medium, and may be composed of at least one of, for example, a ROM (Read Only Memory), an EPROM (Erasable Programmable ROM), an EEPROM (Electrically Erasable Programmable ROM), and a RANI (Random Access Memory). The memory 1002 may be called a register, a cache, a main memory (main storage device), or the like. The memory 1002 can store a program (program code), a software module, and the like that can be executed to perform a method according to the present embodiment.

The storage 1003 is a computer-readable recording medium, and may be composed of at least one of, for example, an optical disk, such as a CD-ROM (Compact Disc ROM), a hard disk drive, a flexible disk, and a magneto-optical disk (e.g. a compact disk, a digital versatile disk, a Blu-ray (registered trademark) disk), a smart card, a flash memory (e.g. a card, a stick, a key drive), a floppy (registered trademark) disk, a magnetic strip, or the like. The storage 1003 may be called an auxiliary storage device. The storage 1003 stores information on the attributes of the aerial vehicle 10, such as identification information of the aerial vehicle 10, model information, flight schedule identification information, and the like.

The communication apparatus 1004 is hardware (a transmission/reception device) for performing communication between computers through at least one of a wired network and a wireless network, and is also referred to as, for example, a network device, a network controller, a network card, a communication module, or the like.

The input apparatus 1005 is an input device that receives inputs from outside (e.g. a keyboard, a mouse, a microphone, a switch, a button, a sensor, and the like). The output apparatus 1006 is an output device that performs output to outside (e.g. a display, a speaker, an LED lamp, and the like). The input apparatus 1005 and the output apparatus 1006 may have an integrated configuration (e.g. a touch panel).

The flying apparatus 1007 is a mechanism for flying the aerial vehicle 10 in the air, and includes, for example, a propeller, and a motor and a drive mechanism for driving the propeller.

The sensor 1008 detects, for example, the condition of the aerial vehicle 10. The sensor 1008 includes a sensor group of, for example, a temperature sensor, a rotation speed sensor that detects the rotation speed of a motor, a sensor that detects a value related to certain input/output such as current/voltage (e.g. a remaining power sensor of a battery), a gyro sensor, an acceleration sensor, an atmospheric pressure (altitude) sensor, a magnetic (azimuth) sensor, and an ultrasonic sensor. Based on the detection results of these sensors, the flight direction and the flight speed of the aerial vehicle 10 are identified.

The positioning apparatus 1009 measures the three-dimensional position of the aerial vehicle 10. The positioning apparatus 1009 is, for example, a GPS (Global Positioning System) receiver, and measures the position of the aerial vehicle 10 on the basis of the GPS signals received from a plurality of satellites. The position of the aerial vehicle 10 is identified on the basis of the positioning result of the positioning apparatus.

The apparatuses, such as the processor 1001 and the memory 1002, are connected by a bus for communicating information. The bus may be configured using a single bus, or may be configured using a different bus for each apparatus.

The aerial vehicle 10 may be configured by including hardware such as a microprocessor, a digital signal processor (DSP), an ASIC (Application Specific Integrated Circuit), a PLD (Programmable Logic Device), and an FPGA (Field Programmable Gate Array). Alternatively, some or all of the functional blocks may be implemented by the hardware. For example, the processor 1001 may be implemented using at least one of these pieces of hardware.

FIG. 3 is a diagram illustrating the hardware configuration of the server device 20. The server device 20 is physically configured as a computer device that mainly includes the processor 2001, the memory 2002, the storage 2003, the communication apparatus 2004, the input apparatus 2005, the output apparatus 2006, and a bus connecting these constituent elements. The functions of the server device 20 are performed by reading predetermined software (program) onto hardware such as the processor 2001 and the memory 2002, so that the processor 2001 carries out calculation, communication is controlled by the communication apparatus 2004, and at least one of the reading and writing of data in the memory 2002 and the storage 2003 is controlled. The processor 2001, the memory 2002, the storage 2003, the communication apparatus 2004, the input apparatus 2005, the output apparatus 2006, and the bus connecting these are the same, as hardware, as the processor 1001, the memory 1002, the storage 1003, the communication apparatus 1004, the input apparatus 1005, the output apparatus 1006, and the bus connecting these described in relation to the aerial vehicle 10, and therefore, the descriptions thereof will be omitted.

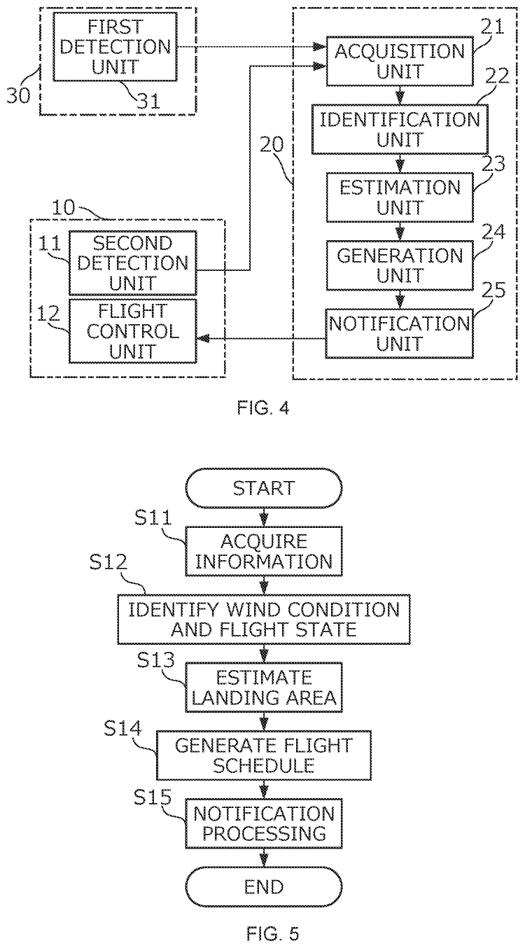

FIG. 4 is a diagram illustrating an example of the functional configuration of the flight control system 1. In the wind detection device 30, a first detection unit 31 detects the wind condition in the space from the road surface of zone A to the predetermined altitude Xm, generates information indicating the detection result, and transmits the information to the server device 20 through the network 2. This information includes the wind direction and the wind speed as the wind condition. If the wind detection device 30 can detect the wind direction and the wind speed at each altitude divided by a certain unit, then the information may include the wind direction and the wind speed at each altitude.

When the aerial vehicle 10 enters an area within a predetermined distance from zone A where the aerial vehicle 10 is expected to land (that is, when the aerial vehicle 10 starts landing or at a certain timing before that), a second detection unit 11 of the aerial vehicle 10 detects the flying condition of the aerial vehicle 10, generates information indicating the detection result, and transmits the information to the server device 20 through the network 2. This information includes, as the condition of the aerial vehicle 10, the information indicating the flying conditions such as the position (including the latitude, the longitude, and the altitude) of the aerial vehicle 10, the flight direction, and the flight speed, as well as the information related to the attributes of the aerial vehicle 10, such as the identification information of the aerial vehicle 10, the model information, or flight schedule identification information. The flight direction and the flight speed are expressed in terms of three-dimensional vectors. More specifically, the flight direction includes the horizontal flight direction and the vertical flight direction of the aerial vehicle 10, and the flight speed includes the horizontal flight speed and the vertical flight speed of the aerial vehicle 10.

In the server device 20, an acquisition unit 21 acquires, through the network 2, the information generated by the first detection unit 31 and the second detection unit 11.

In the server device 20, an identification unit 22 identifies the wind condition and the flight condition of the aerial vehicle 10 on the basis of the information acquired by the acquisition unit 21. More specifically, the identification unit 22 identifies the wind direction and the wind speed, which indicate the wind condition, and the position, the flight direction, and the flight speed of the aerial vehicle 10, which indicate the flight condition of the aerial vehicle 10.

In the server device 20, an estimation unit 23 estimates a landing area where the aerial vehicle 10 is likely to land according to the wind condition and the flight condition of the aerial vehicle 10 which have been identified. Specifically, the estimation unit 23 estimates the landing area according to the relationship between the wind direction and the wind speed of the wind and the flight direction and the flight speed of the aerial vehicle which have been identified.

In the server device 20, a generation unit 24 spatially and temporally combines, in zone A, the landing areas estimated by the estimation unit 23 for the plurality of aerial vehicles 10, and generates a landing schedule of these aerial vehicles 10.

In the server device 20, a notification unit 25 notifies the aerial vehicles 10 of the generated landing schedule.

In the aerial vehicle 10, a flight control unit 12 causes the aerial vehicles 10 to land according to the landing schedule notified from the notification unit 25 of the server device 20.

[Operation]

A description will now be given of the operation of the server device 20. In the following description, when the server device 20 is described as the principal of processing, it specifically means that predetermined software (program) is read onto hardware, such as the processor 2001 and the memory 2002, so that the processor 2001 performs calculation, communication is performed by the communication apparatus 2004, and the reading and/or writing of data in the memory 2002 and the storage 2003 is controlled, thereby executing the processing. The same applies to the aerial vehicle 10.

In FIG. 5, the acquisition unit 21 of the server device 20 acquires the information generated by the first detection unit 31 of the wind detection device 30 and the second detection unit 11 of the aerial vehicle 10 via the network 2 (step S11). At this time, the acquisition unit 21 does not have to acquire the information generated by the first detection unit 31 and the information generated by the second detection unit 11 at the same timing, and may acquire the information at different timings. Further, the acquisition unit 21 acquires the information generated by the second detection unit 11 for each aerial vehicle 10.

Based on the information acquired by the acquisition unit 21, the identification unit 22 of the server device 20 identifies the wind condition (the wind direction and the wind speed) in zone A and the flight condition of the aerial vehicle 10 (the position, the flight direction, the flight speed of the aerial vehicle 10)(step S12).

The estimation unit 23 of the server device 20 estimates a landing area where the aerial vehicle 10 is likely to land according to the relationship between the wind direction and wind speed of the wind and the flight direction and the flight speed of the aerial vehicle 10 which have been identified (Step S13).

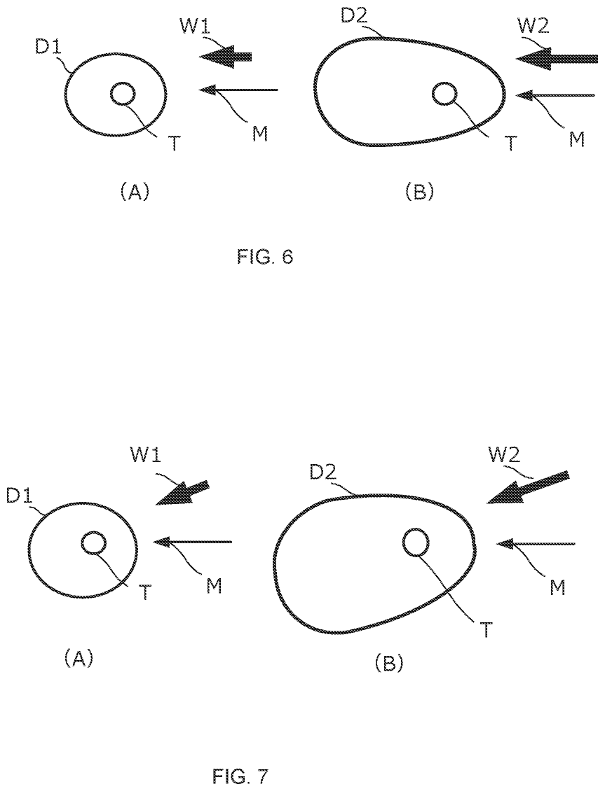

Here, FIG. 6 is a plan view illustrating an example of the landing area of the aerial vehicle 10. In FIG. 6(A), if the wind direction is an arrow W1 (the length of the arrow W1 being proportional to the wind speed), and the aerial vehicle 10 attempts to land on a landing target point T along the course of an arrow M, then the area where the aerial vehicle 10 is likely to land will be a landing area D1. The landing target point T is virtually determined in zone A by the estimation unit 23. The landing area D1 is an area having a certain extent, while the landing target point T corresponds to a certain point. This is because, even if the aerial vehicle 10 attempts to land toward the landing target point T, it is not always possible to land on the landing target point T for reasons such as a change in wind conditions and piloting accuracy. In FIG. 6(A), the arrow W1 denoting the wind direction and the arrow M denoting the course direction of the aerial vehicle 10 with respect to the landing target point T are parallel. In this case, the landing area D1 has a shape closer to an ellipse extending in the directions of the arrow W1 and the arrow M as compared to a true circle centered on the landing target point T. In this example, if, for example, the flight speed of the aerial vehicle 10 before starting the landing is higher, then the landing area D1 will have a shape further extending in the directions of the arrow W1 and the arrow M.

On the other hand, in FIG. 6(B), if the aerial vehicle 10 attempts to land at the landing target point T along the course of the arrow M when the direction of the wind having a wind speed higher than the wind speed denoted by the arrow W1 is an arrow W2 (the length of the arrow W2 being proportional to the wind speed), then the area where the aerial vehicle 10 is likely to land will be a landing area D2. In FIG. 6(B), the arrow W2 denoting the wind direction and the arrow M denoting the course direction of the aerial vehicle 10 with respect to the landing target point T are parallel. In this case, the landing area D2 has a shape further extending in the directions of the arrow W2 and the arrow M as compared with the landing area D1 in FIG. 6(A). Further, in the shape of the landing area D2, the width orthogonal to the directions of the arrow W2 and the arrow M increases as the position advances in the directions of the arrow W2 and the arrow M. In this example, if, for example, the flight speed of the aerial vehicle 10 before starting the landing is higher, then the landing area D2 will have a shape further extending in the directions of the arrow W2 and the arrow M.

In FIG. 6, the wind direction and the course direction of the aerial vehicle 10 are parallel. On the other hand, FIG. 7 is a plan view illustrating an example of the landing area of the aerial vehicle 10 in the case where the wind direction and the course direction of the aerial vehicle 10 are not parallel. In FIG. 7(A), if the wind direction is the arrow W1, and the aerial vehicle 10 attempts to land on the landing target point T along the course of the arrow M, then the area where the aerial vehicle 10 is likely to land will be the landing area D1. In this case, the landing area D1 has a shape that extends in the direction of the arrow W1 as compared with the landing area D1 in FIG. 6(A). In this example, if, for example, the flight speed of the aerial vehicle 10 before starting the landing is higher, then the landing area D1 will have a shape further extending in the direction of the arrow M.

Referring now to FIG. 7(B), if the aerial vehicle 10 attempts to land on the landing target point T along the course of the arrow M when the direction of the wind having a wind speed higher than the wind speed denoted by the arrow W1 is the arrow W2, then the area where the aerial vehicle 10 is likely to land will be the landing area D2. In this case, the landing area D2 has a shape extending further in the direction of the arrow W2 as compared with the landing area D1 in FIG. 7(A). In this example, if, for example, the flight speed of the aerial vehicle 10 before starting the landing is higher, then the landing area D2 will have a shape further extending in the direction of the arrow M.

Thus, the shape and the size of the landing area of the aerial vehicle 10 will be a shape and a size according to the relationship between the wind direction and the wind speed of the wind and the flight direction and the flight speed of the aerial vehicle 10. The correlation between the wind direction and the wind speed of the wind and the flight direction and the flight speed of the aerial vehicle 10, and the shape and the size of the landing area of the aerial vehicle 10 is determined in advance by simulations, experiments, or the like including machine learning. An algorithm indicating the correlation is stored by the estimation unit 23. The estimation unit 23 can estimate the shape and the size of the landing area of the aerial vehicle 10 by inputting the wind direction and the wind speed of the wind and the flight direction and the flight speed of the aerial vehicle 10 to the algorithm.

Further, in the case where the wind detection device 30 can detect the wind direction and the wind speed at each altitude divided by a certain unit, the algorithm is used to estimate the shape and size of the landing area on the basis of the wind direction and the wind speed at each altitude. It should be noted that the relationship between the wind direction, the wind speed, the course direction of the aerial vehicle 10, the landing target point, and the landing area illustrated in FIG. 6 and FIG. 7 is merely an example for an easy-to-understand description, and does not necessarily mean that every case will have the relationship as illustrated.

Returning to the description of FIG. 5, the generation unit 24 of the server device 20 spatially and temporally combines, in zone A, the landing areas estimated by the estimation unit 23 for the plurality of aerial vehicles 10, and generates the landing schedules for the aerial vehicles 10 (step S14). Specifically, based on the shape and size of each landing area estimated for each of the aerial vehicles 10 scheduled to land in the same time zone, the generation unit 24 combines the placements of the landing areas in zone A such that the landing areas do not overlap. When the combination of the placements of the landing areas is determined, a landing target point in each landing area is determined. The landing schedules include information indicating the positions of the landing target points.

Next, the notification unit 25 notifies the aerial vehicle 10 of the generated landing schedule (step S15). In the aerial vehicle 10, the flight control unit 12 causes the aerial vehicle 10 to land, aiming at the landing target point in accordance with the landing schedule notified from the notification unit 25 of the server device 20.

According to the embodiment described above, the shape and the size of the landing area of the aerial vehicle 10 are estimated according to the relationship between the wind direction and the wind speed of the wind and the flight direction and the flight speed of the aerial vehicle 10, thus making it possible to further accurately estimate the shape and the size of the landing area.

### MODIFICATION EXAMPLES

The present invention is not limited to the embodiment described above. The foregoing embodiment may be modified as described below. Further, two or more of the following modification examples may be combined and implemented.

### Modification Example 1

In the estimation of a landing area by the estimation unit 23, the wind condition and the flight condition of the aerial vehicle 10 have been used. However, the estimation unit 23 may alternatively estimate the landing area by using at least the wind condition. For example, in the case where it is determined that the aerial vehicle 10 lands in zone A at a predetermined speed and a predetermined course from a predetermined position, or in the case where the kind of speed along which course and from which position the aerial vehicle 10 will take to land in zone A is not significantly important, the estimation unit 23 can estimate the landing area by using only the wind condition. The wind condition is not limited to the wind direction and the wind speed, but may include any condition related to wind, such as, for example, the stability of the wind direction or the wind speed (gust hardly/frequently blows or the wind direction hardly changes/frequently changes). For example, if the wind direction or the wind speed is unstable, such as when a gust frequently blows or when the wind direction frequently changes, then the size of the landing area will be larger than when the wind direction or the wind speed is stable.

### Modification Example 2

In estimating a landing area by the estimation unit 23, the following conditions may be used in addition to the wind condition described in the embodiment. For example, the estimation unit 23 may estimate the landing area according to the structure of the aerial vehicle 10 related to the flight. The structure of the aerial vehicle 10 related to the flight includes, for example, a structure using rotating wings as a main floating means and a structure using non-rotating wings as a main floating means. For example, the aerial vehicle 10 having the rotating wings as the main floating means has a higher capability of braking an increase in the flight speed of the aerial vehicle 10 due to tailwind, as compared with the aerial vehicle 10 having the non-rotating wings as the main floating means. For this reason, when the aerial vehicle 10 having the non-rotating wings as the main floating means is subjected to a tailwind during landing, it is considered that the landing area will have a shape more extended in the leeward direction than the landing area shown in FIG. 6(A). On the other hand, the aerial vehicle 10 having the non-rotating wings as the main floating means can reduce the deceleration of the aerial vehicle 10 due to a headwind at the time of landing, as compared with the aerial vehicle 10 having the rotating wings as the main floating means. Therefore, the landing area when the aerial vehicle 10 having the non-rotating wings as the main floating means is subjected to a headwind at the time of landing, it is considered that the shape will be shorter in the wind direction than in the landing area when the aerial vehicle 10 having the rotating wings as the main floating means is subjected to the headwind at the time of landing.

Thus, the shape and the size of the landing area of the aerial vehicle 10 will be a shape and a size based on the relationship between the wind condition and the structure of the aerial vehicle 10 related to flight. The correlation between the wind condition and the structure of the aerial vehicle 10 related to flight, and the shape and the size of the landing area of the aerial vehicle 10 is determined by simulations, experiments, or the like including machine learning, and an algorithm indicating the correlation is stored by the estimation unit 23. The estimation unit 23 can estimate the shape and the size of the landing area of the aerial vehicle 10 by inputting the wind condition and the structure of the aerial vehicle 10 related to flight to the algorithm. The structure of the aerial vehicle 10 related to flight may be identified mainly by referring to a database according to the identification information or the model information of the aerial vehicle 10 included in the information acquired from the aerial vehicle 10 by the acquisition unit 21 of the server device 20.

### Modification Example 3

The estimation unit 23 may estimate a landing area according to the performance of the aerial vehicle 10 that counters wind. The wind countering performance differs depending on, for example, the structure related to the flight described in modification example 2, and also differs, even with the same structure, depending on the size or the volume of the aerial vehicle 10, the superiority of the countering performance thereof, or the magnitude of power that can be output. For example, if the aerial vehicle 10 having low wind countering performance is subjected to a tailwind at the time of landing, then the landing area is considered to have a shape further extended in the leeward direction, as compared with the aerial vehicle 10 having high wind countering performance. The correlation between the wind condition and the wind countering performance of the aerial vehicle 10 and the shape and the size of the landing area of the aerial vehicle 10 is determined by simulations, experiments, or the like including machine learning, and an algorithm indicating the correlation is stored by the estimation unit 23. The estimation unit 23 can estimate the shape and size of the landing area of the aerial vehicle 10 by inputting the wind condition and the wind countering performance of the aerial vehicle 10 to the algorithm. The wind countering performance of the aerial vehicle 10 may be identified by mainly referring to a database of the identification information or the model information of the aerial vehicle 10 included in the information acquired from the aerial vehicle 10 by the acquisition unit 21 of the server device 20.

### Modification Example 4

The estimation unit 23 may estimate a landing area according to the weight of the aerial vehicle 10 or the weight of the load on the aerial vehicle 10. For example, if the aerial vehicle 10 having a small weight or the aerial vehicle 10 loaded with a small weight is subjected to a tailwind at the time of landing, then the landing area is considered to have a shape further extended in the leeward direction, as compared with the aerial vehicle 10 having a large weight or loaded with a large weight. The correlation between the wind condition and the weights and the shape and the size of the landing area of the aerial vehicle 10 is determined by simulations, experiments, or the like including machine learning, and an algorithm indicating the correlation is stored by the estimation unit 23. The estimation unit 23 can estimate the shape and size of the landing area of the aerial vehicle 10 by inputting the wind condition and the weights to the algorithm. The weight of the aerial vehicle 10 or the weight of the load on the aerial vehicle 10 may be identified by mainly referring to a database of the identification information or model information of the aerial vehicle 10 included in the information acquired from the aerial vehicle 10 by the acquisition unit 21 of the server device 20.

### Modification Example 5

The estimation unit 23 may estimate a landing area according to the skill of piloting the aerial vehicle 10. For example, if an aerial vehicle 10 piloted by an operator with a low level of piloting skill is subjected to a tailwind at the time of landing, then the landing area is considered to have a shape further extended in the leeward direction, as compared with the aerial vehicle 10 piloted by an operator with a high level of piloting skill. If it is assumed that manual piloting has a lower level of piloting technique than automatic piloting and if the aerial vehicle 10 under the manual piloting is subjected to a tailwind at the time of landing, then it is considered that the shape of the landing area will have a shape further extended in the leeward direction, as compared with the aerial vehicle 10 under the automatic piloting. The correlation between the parameters related to the wind condition and the skill of piloting the aerial vehicle 10 and the shape and the size of the landing area of the aerial vehicle 10 is determined by simulations, experiments, or the like including machine learning, and an algorithm indicating the correlation is stored by the estimation unit 23. The estimation unit 23 can estimate the shape and the size of the landing area of the aerial vehicle 10 by inputting the wind condition and the parameters related to the technique of piloting the aerial vehicle 10 into the algorithm. The parameters related to the technique of piloting the aerial vehicle 10 may be identified by mainly referring to a database of the identification information or the model information of the aerial vehicle 10 included in the information acquired from the aerial vehicle 10 by the acquisition unit 21 of the server device 20.

### Modification Example 6

The estimation unit 23 may estimate a landing area according to the condition of a road surface on which the aerial vehicle 10 lands. For example, if the aerial vehicle 10 moves or slides on a road surface, keeping the direction of flight, for a while after coining into contact with the road surface in zone A, then the magnitude of the frictional resistance of the road surface affects the size of the landing area. The landing area in this case corresponds to an area required from the moment the aerial vehicle 10 comes into contact with the road surface in zone A to the moment the aerial vehicle 10 completely stops. The correlation between a wind condition and the condition of a road surface on which the aerial vehicle 10 lands, and the shape and the size of a landing area of the aerial vehicle 10 is determined by simulations, experiments, or the like including machine learning, and an algorithm indicating the correlation is stored by the estimation unit 23. The estimation unit 23 can estimate the shape and the size of the landing area of the aerial vehicle 10 by inputting the wind condition and the condition of the road surface on which the aerial vehicle 10 lands to the algorithm. The condition of the road surface on which the aerial vehicle 10 lands is determined in advance for each zone A, and the condition is stored in the server device 20. Alternatively, the server device 20 may identify a road surface condition on the basis of information acquired from outside. For example, if a sensor for measuring the atmospheric pressure, the amount of rainfall, or the amount of snowfall in zone A is connected to the network 2, then the server device 20 may acquire the atmospheric pressure, the amount of rainfall, or the amount of snowfall from the sensor to estimate the state of rainfall or the snowfall in zone A, and may identify the condition of the road surface in zone A from the state of the rainfall or the snowfall. Further, if a weather information providing device that accumulates and updates weather information including the amount of rainfall, the amount of snowfall, or the like in zone A is connected to the network 2, then the server device 20 may acquire the weather information from the weather information providing device to estimate the state of rainfall or snowfall in zone A, and may identify the condition of the road surface in zone A from the state of the rainfall or snowfall.

### Modification Example 7

The estimation unit 23 may estimate a landing area according to the state of a missing radio signal for controlling the aerial vehicle 10. For example, in an automatic flight, a radio signal for controlling the aerial vehicle 10 is transmitted through the network 2, and the aerial vehicle 10 controls its own flight on the basis of the radio signal. Further, in a manual flight, a radio signal for controlling the aerial vehicle 10 is transmitted through the network 2 or the like from a remote controller used by an operator, and the aerial vehicle 10 controls its own flight on the basis of the radio signal. If the communication environment of such a radio signal is poor, frequently resulting in so-called packet loss or the like, then the control of the aerial vehicle 10 is delayed. Therefore, it is considered that the landing area will have a shape extended in the flight direction of the aerial vehicle 10, as compared with a case where there is no such missing radio signal. The correlation between the wind condition and the state of a missing radio signal and the shape and the size of the landing area of the aerial vehicle 10 is determined by simulations, experiments, or the like including machine learning, and an algorithm indicating the correlation is stored by the estimation unit 23. The estimation unit 23 can estimate the shape and the size of the landing area of the aerial vehicle 10 by inputting the wind condition and the state of a missing radio signal to the algorithm. The state of a missing radio signal can be identified on the basis of the presence or absence of an Ack signal when the aerial vehicle 10 receives the radio signal, so that the server device 20 may acquire the result of the identification.

### Modification Example 8

The function of the server device 20 (information processing device) may be distributed and provided by a plurality of devices. Further, the aerial vehicle 10 may replace at least a part of the function of the server device 20 (information processing device). In the foregoing embodiment, the method for measuring the position of the aerial vehicle 10 is not limited to the method using the GPS. The position of the aerial vehicle 10 may be measured by a method not using the GPS.

### Other Modification Examples

The block diagrams used in the description of the foregoing embodiment illustrate blocks in functional units. These functional blocks (components) are implemented by a random combination of at least one of hardware and software. Further, a method of implementing each functional block is not particularly limited. More specifically, each functional block may be implemented using one device physically or logically coupled, or directly or indirectly connecting (for example, wired or wireless) two or more devices that are physically or logically separated from each other, and may be implemented using the plurality of devices. The functional block may be implemented by combining software with one device or the plurality of devices mentioned above.

The functions include but are not limited to: judgment, decision, determination, computation, calculation, processing, derivation, investigation, search, confirmation, reception, transmission, output, access, resolution, selection, appointment, establishment, comparison, assumption, expectation, deeming, broadcasting, notifying, communicating, forwarding, configuring, reconfiguring, allocating, mapping, and assigning. For example, a functional block (configuration unit) that causes transmission to function is called a transmitting unit or a transmitter. In any case, as described above, the implementation method is not particularly limited.

For example, a server, a client, or the like in an embodiment of the present disclosure may function as a computer that performs the processing of the present disclosure.

Each mode/embodiment described in the present disclosure may be applied to at least one of LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), a system using other appropriate systems, and next generation systems extended based thereon. Further, a plurality of systems may be combined (for example, a combination of at least one of LTE and LTE-A with 5G) and applied.

The processing procedure, sequence, flowchart, and the like of each mode/embodiment described in the present disclosure may be reordered as long as there is no contradiction. For example, regarding the methods described in the present disclosure, elements of various steps are presented in an exemplary order, and are not limited to any specific order presented.

Input and output information and the like may be stored in a specific place (e.g. a memory) or may be managed using a management table. Information and the like that is input and output can be overwritten, updated, or added. Output information and the like may be deleted. Input information and the like may be transmitted to another device.

Determination may be made on the basis of a value represented by 1 bit (0 or 1), a Boolean value (Boolean: true or false), or the comparison of numerical values (e.g. the comparison with a predetermined value).

Each mode/embodiment described in the present disclosure may be used alone or in combination, or may be switched and used in the course of implementation. Further, the notification of predetermined information (e.g. the notification of “being X”) is not limited to being explicitly performed, and may alternatively be performed implicitly (e.g. not performing the notification of the predetermined information).

Although the present disclosure has been described in detail above, it is obvious to those skilled in the art that the present disclosure is not limited to the embodiments described in the present disclosure. The present disclosure can be implemented as modified and changed modes without departing from the spirit and scope of the present disclosure defined by the description of the claims. Therefore, the description of the present disclosure is intended for illustrative purposes, and has no restrictive meaning for the present disclosure.

Software, regardless of whether it is called software, firmware, middleware, microcode, a hardware description language, or any other name, should be broadly interpreted to mean instructions, instruction sets, codes, code segments, program codes, programs, subprograms, software modules, applications, software applications, software packages, routines, subroutines, objects, executables, threads of execution, procedures, functions, and the like.

Further, software, instructions, information, and the like may be transmitted and received through a transmission medium. For example, if software is transmitted from a website, a server, or other remote source by using at least one of wired technology (a coaxial cable, a fiber optic cable, a twisted pair, a digital subscriber line (DSL), and the like) and wireless technology (infrared, microwave, and the like), then at least one of these wired and wireless technologies is included in the definition of a transmission medium.

The information, signals, and the like described in the present disclosure may be represented using any of a variety of different technologies. For example, data, instructions, commands, information, signals, bits, symbols, chips, and the like that can be referred to throughout the above description may be represented by voltages, currents, electromagnetic waves, magnetic fields or magnetic particles, optical fields or photons, or any combination of these.

The terms described in the present disclosure and the terms necessary for understanding the present disclosure may be replaced with terms having the same or similar meanings.

Further, the information, the parameters, and the like described in the present disclosure may be represented using absolute values, may be represented using relative values from predetermined values, or may be represented using other corresponding information.

The phrase “on the basis of” used in the present disclosure does not mean “only on the basis of” unless otherwise specified. In other words, the phrase “on the basis of” means both “only on the basis of” and “at least on the basis of.”

Any reference to elements using designations such as “first,” “second,” and the like used in the present disclosure, does not generally limit the quantity or order of the elements. These designations can be used in the present disclosure as a convenient way to distinguish between two or more elements. Thus, references to first and second elements do not mean that only two elements can be employed, or that the first element must precede the second element in some way.

The “means” in the configuration of each device described above may be replaced by “units,” “circuits,” “devices,” and the like.

In the present disclosure, in the case where the terms “include”, “including” and variations thereof are used, these terms are intended to be as inclusive as the term “comprising.” Further, the term “or” used in the present disclosure is intended not to be an exclusive OR.

In the present disclosure, in the case where articles are added in translation, such as a, an, and the in English, the present disclosure may include a case where nouns following these articles are plural.

In the present disclosure, the term “A and B are different” may mean “A and B are different from each other.” The term may also mean that “each of A and B is different from C.” Terms such as “separate,” “coupled,” and the like may be interpreted as with “different.”

### DESCRIPTION OF REFERENCE NUMERALS

1: flight control system; 10: aerial vehicle; 11: detection unit; 12: flight control unit; 1001: processor; 1002: memory; 1003: storage; 1004: communication apparatus; 1005: input apparatus; 1006: output apparatus; 1007: flying apparatus; 1008: sensor; 1009: positioning apparatus; 20: server device; 21: acquisition unit; 22: identification unit; 23: estimation unit; 24: generation unit; 25: notification unit; 2001: processor; 2002: memory; 2003: storage; 2004: communication device; 2005: input apparatus; and 2006: output apparatus.

What is claimed is:

1-9. (canceled)

10. An information processing apparatus comprising
an identification unit that identifies a wind condition in a flight airspace of an aerial vehicle; and
an estimation unit that estimates a landing area where the aerial vehicle is likely to land according to the identified wind condition.

11. The information processing apparatus according to claim 10,
wherein the estimation unit estimates the landing area according to a flying state of the aerial vehicle at the time of landing.

12. The information processing apparatus according to claim 11,
wherein the estimation unit estimates the landing area according to a relationship between a wind direction and a wind speed of the wind identified as the wind condition and a flight direction and a flight speed of the aerial vehicle at the time of landing.

13. The information processing apparatus according claim 10,
wherein the estimation unit estimates the landing area according to a structure of the aerial vehicle related to flight.

14. The information processing apparatus according to claim 10,
wherein the estimation unit estimates the landing area according to wind countering performance of the aerial vehicle.

15. The information processing apparatus according to claim 10,
wherein the estimation unit estimates the landing area according to the weight of the aerial vehicle or the weight of a load of the aerial vehicle.

16. The information processing apparatus according to claim 10,
wherein the estimation unit estimates the landing area according to the technique of piloting the aerial vehicle.

17. The information processing apparatus according to claim 10,
wherein the estimation unit estimates the landing area according to a condition of a road surface onto which the aerial vehicle lands.

18. The information processing apparatus according to claim 10,
wherein the estimation unit estimates the landing area according to the state of a missing radio signal for controlling the aerial vehicle.
